(19) United States
(12) Patent Application Publication
(10) Pub. No.: US 2026/0360139 A1
(43) Pub. Date: Nov. 12, 2026

(54) USER INTERACTION-BASED DETECTION ERROR COLLECTION SYSTEM AND METHOD THEREOF

(71) Applicant: Electronics and Telecommunications Research Institute, Daejeon (KR)

(72) Inventors: DEOKYUN KIM, Daejeon (KR); Jihun CHA, Daejeon (KR)

(21) Appl. No.: 19/397,581

(22) Filed: Nov. 21, 2025

(30) Foreign Application Priority Data
May 8, 2025 (KR) 10-2025-0059819

(51) Int. Cl. G06V 10/98; G06V 10/25; G06V 10/776

(52) U.S. Cl. CPC G06V 10/987; G06V 10/25; G06V 10/776

(57) ABSTRACT

A detection error collection system comprises a data management unit configured to store training data, a guide generation unit configured to generate a guide box based on the training data, a user input unit configured to receive a real-time image from a user, an inference unit configured to detect an object included in the real-time image, and an analysis unit configured to analyze an object detection result of the inference unit. The user input unit comprises a capturing unit configured to receive the real-time image based on the guide box from the user and an operation unit configured to receive an object signal from the user.

### CROSS-REFERENCE TO RELATED APPLICATIONS

This application claims priority under 35 U.S.C. § 119 to Korean Patent Application No. 10-2025-0059819 filed on May 8, 2025, in the Korean Intellectual Property Office, the disclosures of which are incorporated by reference herein in their entireties.

### BACKGROUND

The present disclosure relates to artificial intelligence (AI)-based object detection technology, and more particularly, to a system that analyzes statistical characteristics of previously collected training data, provides a guide box to a user to actively acquire data types that are insufficient or missing in the statistics, and automatically collects data when detection failure occurs in the corresponding region.

With recent advances in artificial intelligence (AI) technologies, object detection techniques have been utilized in a variety of applications, including autonomous driving, image surveillance, industrial robotics, and drone-based exploration. These object detection techniques are primarily implemented using deep learning models trained on large-scale image datasets. However, such datasets are largely composed of images collected in structured environments, such as urban areas, indoor spaces, and traffic scenes. Accordingly, object detection performance tends to deteriorate significantly in complex and unstructured environments, such as forests, natural landscapes, or under extreme weather conditions. To address this issue, there is a need for an active data collection system capable of clearly identifying detection failure cases and supplementing insufficient types of data.

### SUMMARY

The present disclosure addresses the problem of preventing omission of detection failure cases and improving the training effectiveness and real-world applicability of an AI detection model by ensuring data diversity and balance. To this end, the present disclosure provides a user interaction-based detection error collection system and method.

A detection error collection system according to one embodiment of the present disclosure comprises a data management unit configured to store training data, a guide generation unit configured to generate a guide box based on the training data, a user input unit configured to receive a real-time image from a user, an inference unit configured to detect an object included in the real-time image, and an analysis unit configured to analyze an object detection result of the inference unit. The user input unit comprises a capturing unit configured to receive the real-time image based on the guide box from the user and an operation unit configured to receive an object signal from the user.

In one embodiment, the data management unit comprises: a database configured to store training data and information about the training data; and a preprocessing unit configured to perform Kernel Density Estimation (KDE) based on the information on the bounding box of the training data, and to perform Rejection Sampling based on the KDE results.

In one embodiment, the Kernel Density Estimation (KDE) is determined based on the equation below.

$$\hat{{f}_{h}} ( x ) = \frac{1}{n h} {\sum }_{i = 1}^{n} K ( \frac{x - {x}_{i}}{h} )$$

In equation, x represents the coordinates of an existing bounding box, \hat{f}ₕ(x) denotes the estimated probability density function value, n is the number of data points, h is the bandwidth, xᵢ is the i-th observed data point, and K(⋅) is a kernel function.

In one embodiment, the guide generation unit generates a plurality of candidate guide boxes based on results provided from the data management unit, and selects a single guide box through a validity check performed on the candidate guide boxes. The validity check is performed based on whether each candidate guide box exceeds a screen boundary and whether it overlaps with bounding boxes of the training data.

In one embodiment, the capturing unit includes a device with a display and a camera, and the guide generation unit displays the guide box on the display of the device.

In one embodiment, the object signal may be input through at least one of a shutter button click, a touch input, a keyboard input, or a voice command.

In one embodiment, the inference unit uses a pre-trained deep learning-based object detection model, where the model has been pre-trained using training data and considers the object signal as ground truth.

In one embodiment, the analysis unit determines a frame to be a detection failure based on at least one of the following conditions: no detection result is produced by the inference unit; the confidence score produced by the inference unit is below a threshold; or the Intersection over Union (IoU) between a detected bounding box and the guide box is below a reference value.

In one embodiment, the analysis unit stores the frame corresponding to a detection failure along with metadata in the data management unit. The metadata may include at least one of a frame ID, detection result, confidence score, and user input timestamp.

In one embodiment, the detection error collection system includes a power unit that controls activation and termination of the detection error collection system. The power unit shuts off the power supply to the detection error collection system based on a shutdown signal input by the user.

According to one embodiment of the present disclosure, a method for operating a detection error collection system that collects object detection failure data comprises: preprocessing training data by a data management unit; generating a guide box based on results of the preprocessing by a guide generation unit; receiving a real-time image from a user by a capturing unit; detecting an object included in the real-time image by an inference unit; receiving an object signal from the user by an operation unit; and determining a detection failure based on object detection results from the inference unit and the object signal from the operation unit by an analysis unit.

In one embodiment, the preprocessing of the training data comprises: activating the detection error collection system by a power unit; loading bounding box data of the training data by a database; performing kernel density estimation (KDE) on the coordinates and sizes of the bounding boxes by a preprocessing unit; generating a probability density function based on result of the kernel density estimation by the preprocessing unit; and performing rejection sampling based on the probability density function by the preprocessing unit.

In one embodiment, the Kernel Density Estimation (KDE) is determined based on the equation below.

$$\hat{{f}_{h}} ( x ) = \frac{1}{n h} {\sum }_{i = 1}^{n} K ( \frac{x - {x}_{i}}{h} )$$

In equation, x represents the coordinates of an existing bounding box, \hat{f}ₕ(x) denotes the estimated probability density function value, n is the number of data points, h is the bandwidth, xᵢ is the i-th observed data point, and K(⋅) is a kernel function.

In one embodiment, generating a guide box based on a preprocessing result comprises: generating a plurality of candidate guide boxes based on coordinates included in the preprocessing result by a guide generation unit included in the detection error collection system; performing a validity check on the candidate guide boxes by the guide generation unit; and selecting one of the candidate guide boxes by the guide generation unit. The validity check is performed based on whether each candidate guide box exceeds a screen boundary and whether it overlaps with bounding boxes of the training data.

In one embodiment, detecting an object in a real-time image comprises: loading the real-time image by the inference unit included in the detection error collection system; dividing the real-time image into frames by the inference unit; identifying an object location and a class using an object detection model by the inference unit; and transmitting the object location and the class to the analysis unit by the inference unit.

In one embodiment, determining a detection failure based on the detection result from the inference unit and the object signal from the operation unit comprises: extracting a frame corresponding to the time of the object signal input by an analysis unit included in the detection error collection system; applying the object detection model to the extracted frame by the inference unit; determining a detection failure by the analysis unit based on no bounding box detected in the detection result; determining a detection failure by the analysis unit based on the confidence score of the detection result below a threshold; and determining a detection failure by the analysis unit based on the Intersection over Union (IoU) between the predicted bounding box and the guide box below a reference value.

In one embodiment, determining detection failure based on the detection result and object signal further includes storing a frame determined as a detection failure and corresponding metadata in a database included in the detection error collection system. The metadata includes at least one of a frame ID, detection result, confidence score, and user input timestamp.

In one embodiment, the operation method of the detection error collection system further includes regenerating the guide box based on the preprocessing result by the guide generation unit, and receiving a new real-time image from the user by the capturing unit included in the detection error collection system.

In one embodiment, the operation method of the detection error collection system includes receiving a shutdown signal from the user by a power unit included in the detection error collection system, and shutting off power supply to the detection error collection system by the power unit.

### BRIEF DESCRIPTION OF THE FIGURES

The above and other objects and features of the present disclosure will become apparent by describing in detail embodiments thereof with reference to the accompanying drawings.

FIG. 1 illustrates the configuration of a detection error collection system according to an embodiment of the present disclosure.

FIG. 2 illustrates a detailed configuration of the detection error collection system shown in FIG. 1.

FIG. 3 is a flowchart illustrating an operation method of the detection error collection system shown in FIGS. 1 and 2.

FIG. 4 is a flowchart illustrating an operation method in which the data management unit performs preprocessing of training data in step S100.

FIG. 5 is a flowchart illustrating an operation method in which the guide generation unit generates a guide box in step S200.

FIG. 6 is a flowchart illustrating an operation method in which the inference unit detects objects in a real-time image in step S400.

FIG. 7 is a flowchart illustrating an operation method in which the user inputs an object signal via the operation unit in step S500.

FIG. 8 is a schematic diagram illustrating an operation flow according to the embodiment of FIG. 7.

FIG. 9 is a flowchart illustrating an operation method in which the analysis unit analyzes the object detection result and the object signal to determine detection failure in step S600.

FIG. 10 is a graph illustrating a two-dimensional distribution of the center coordinates of bounding boxes collected from training data.

FIG. 11 is a diagram showing the results of Kernel Density Estimation (KDE) performed on the bounding box center coordinates, expressed as a heatmap.

FIGS. 12A to 12D are scatter plots showing candidate guide box coordinates generated by applying rejection sampling.

FIG. 13 is a block diagram of a system according to an embodiment of the present disclosure.

### DETAILED DESCRIPTION

Hereinafter, embodiments of the present disclosure will be described clearly and in detail to such an extent that a person having ordinary skill in the art can easily carry out the disclosure.

The terms “unit,” “module,” and the functional blocks shown in the drawings may be implemented in the form of software, hardware, or a combination thereof. In the following description, detailed explanations of duplicate components will be omitted for clarity in describing the technical features of the present invention.

As used herein, expressions such as “A or B,” “at least one of A and B,” “at least one of A or B,” “A, B, or C,” “at least one of A, B, and C,” and “at least one of A, B, or C” are intended to include any one of the listed elements or any combination of two or more thereof.

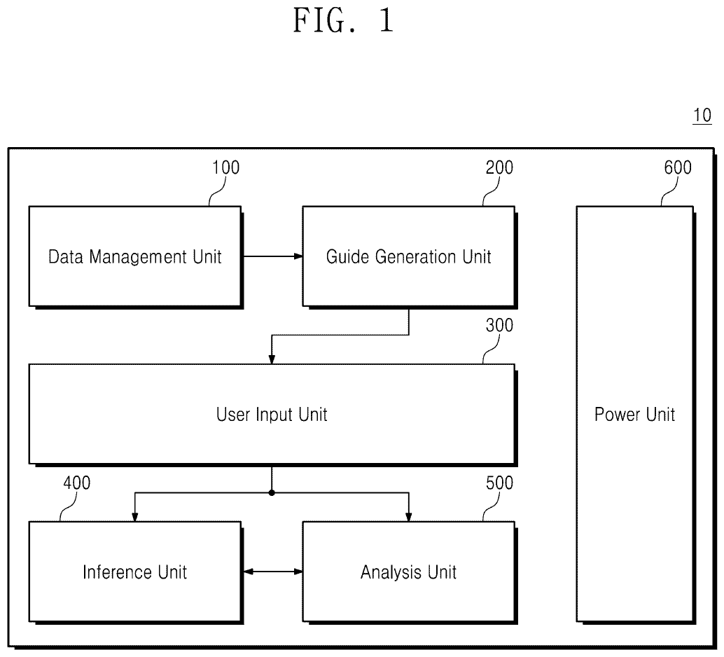

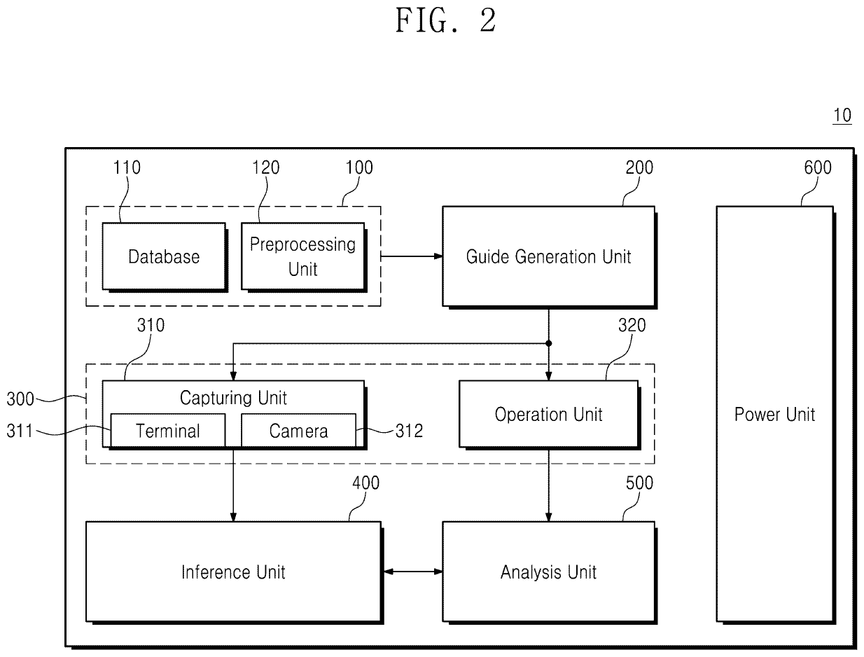

FIG. 1 illustrates the configuration of a detection error collection system 10 according to an embodiment of the present disclosure. FIG. 2 illustrates a detailed configuration of the detection error collection system 10 shown in FIG. 1.

Referring to FIGS. 1 and 2, the detection error collection system 10 may include a data management unit 100, a guide generation unit 200, a user input unit 300, an inference unit 400, an analysis unit 500, and a power unit 600.

The data management unit 100 may include a database 110 and a preprocessing unit 120. The database 110 may store training data used in the detection error collection system 10. The preprocessing unit 120 may perform preprocessing on the training data.

In one embodiment, the database 110 may store the training data, bounding box information related to the training data, detection failure images, user input logs, and detection results. The bounding box information may include the center coordinates (cx, cy) and size (w, h) of the bounding boxes. Here, cx represents the x-coordinate of the center of the bounding box, cy represents the y-coordinate of the center of the bounding box, w represents the width of the bounding box, and h represents the height of the bounding box.

In one embodiment, the training data may include pre-collected training data. Publicly available large-scale datasets such as COCO (Common Objects in Context), VOC (Visual Object Classes), and CrowdHuman may be used as the training data.

In one embodiment, the preprocessing unit 120 may perform Kernel Density Estimation (KDE) based on the bounding box information of the training data to non-parametrically estimate the distribution of the bounding box information. The preprocessing unit 120 may generate a probability density function in high-dimensional space based on the KDE results. The preprocessing unit 120 may perform rejection sampling based on the generated probability density function.

In one embodiment, the Kernel Density Estimation (KDE) performed by the preprocessing unit 120 may be determined by Equation 1 below.

$$\hat{{f}_{h}} ( x ) = \frac{1}{n h} {\sum }_{i = 1}^{n} K ( \frac{x - {x}_{i}}{h} ) \qquad [ Equation 1 ]$$

In equation 1, x represents the coordinates of an existing bounding box, \hat{f}ₕ(x) denotes the estimated probability density function value, n is the number of data points, h is the bandwidth, xᵢ is the i-th observed data point, and K(⋅) is a kernel function.

In one embodiment, the preprocessing unit 120 may generate a probability density function in high-dimensional space based on the KDE results. For example, the preprocessing unit 120 may generate the probability density function based on equation 1.

In one embodiment, the kernel function may be selected depending on the characteristics of the data distribution. Kernel functions such as the Gaussian kernel, Epanechnikov kernel, Uniform kernel, Triangular kernel, Biweight (Quartic) kernel, Triweight kernel, and Cosine kernel may be used.

In one embodiment, the user may preferentially perform sampling in sparse regions through rejection sampling, while reflecting the density distribution of the training data. The user may increase the sampling probability in sparse regions through rejection sampling.

In one embodiment, the preprocessing unit 120 may generate a probability density function in high-dimensional space based on the KDE results. For example, the preprocessing unit 120 may generate the probability density function based on equation 1. The probability density function may numerically represent the distribution characteristics of the bounding boxes. It may be used as a key reference in sampling, anomaly detection, or statistical analysis. The probability density function may be constructed in a non-parametric manner, allowing the characteristics of the data to be flexibly reflected without assuming a specific distribution in advance.

The guide generation unit 200 may generate a guide box corresponding to a sampling location and size based on information sampled by the data management unit 100. The guide generation unit 200 may generate a plurality of candidate guide boxes. The guide generation unit 200 may select a final guide box from among the candidate guide boxes.

In one embodiment, the guide generation unit 200 may perform a validity check on the candidate guide boxes. The validity check may include determining whether the guide box is outside the screen, whether it overlaps with existing bounding boxes in the training data, and whether it belongs to a biased region or has a biased size.

In one embodiment, the guide generation unit 200 may display the guide box to the user input unit 300. The user may input an object signal based on the displayed guide box.

The user input unit 300 may include a capturing unit 310 and an operation unit 320. The capturing unit 310 may receive a real-time image. The operation unit 320 may receive the object signal from the user.

In one embodiment, the capturing unit 310 may include a terminal 311 equipped with a display and a camera 312. The guide generation unit 200 may display the final guide box on the display of the terminal 311. The terminal 311 may be a laptop, tablet, or desktop computer.

In one embodiment, the operation unit 320 may receive the object signal through a shutter button press, touchscreen input, keyboard input, or voice command. The user may guide an object into the final guide box and input the object signal based on the object positioned within the guide box.

In one embodiment, the object signal input through the operation unit 320 may be used as ground truth for the inference unit 400.

The inference unit 400 may detect an object in the input real-time image using an object detection model. The inference unit 400 may detect the object in a frame corresponding to the time point based on the object signal input by the user.

In one embodiment, the inference unit 400 may use a pretrained object detection model. The object detection model may include a model trained in advance using both the dataset collected by the detection error collection system 10 and large-scale public datasets.

In one embodiment, the inference unit 400 may use a deep learning-based object detection model. Examples include models in the YOLO (You Only Look Once) family, RetinaNet, EfficientDet, DETR (Detection Transformer), Deformable DETR, DINO, DN-DETR, and Sparse R-CNN.

In one embodiment, the inference unit 400 may recognize multiple object classes including humans. It may calculate a confidence score for each class, and identify the object as a human only based on the confidence score that exceeds a predefined threshold.

In one embodiment, the inference unit 400 may transmit coordinate and size information of the detected object to the analysis unit 500. The coordinate information may be expressed as the pixel coordinates of the top-left and bottom-right corners of the bounding box or as the center coordinates along with width and height. The inference unit 400 may also transmit class information for each object along with its corresponding confidence score to the analysis unit 500.

The analysis unit 500 may determine whether a detection failure has occurred by comparing the detection results from the inference unit 400 with the time point at which the object signal was input. The analysis unit 500 may store the frame determined as a detection failure along with metadata in the database 110.

In one embodiment, the analysis unit 500 may input to the inference unit 400 the frame at which the object signal was received, as well as frames immediately before and after that time point. The analysis unit 500 may determine it as a detection failure based on no object detected at the relevant time point (i.e., no predicted bounding box exists). Even when a bounding box is predicted, the analysis unit 500 may determine it as a detection failure based on the confidence score below a predefined threshold. The analysis unit 500 may also determine it as a detection failure based on the Intersection over Union (IoU) value between the predicted bounding box and the guide box, below a reference value (e.g., 0.3).

In one embodiment, the analysis unit 500 may store the frame determined as a detection failure and corresponding metadata in the database 110. The metadata may include the confidence score and the time point at which the object signal was input.

In one embodiment, the object detection model used by the inference unit 400 may use the frames and metadata corresponding to detection failures as training data.

The power unit 600 may supply power to the detection error collection system 10 and enable its operation. When power is supplied from the power unit 600, the data management unit 100 included in the detection error collection system 10 may begin operating. The power unit 600 may terminate the operation of the detection error collection system 10. When an explicit shutdown signal is input to the power unit 600 by the user, the power unit 600 may cut off power to the detection error collection system 10.

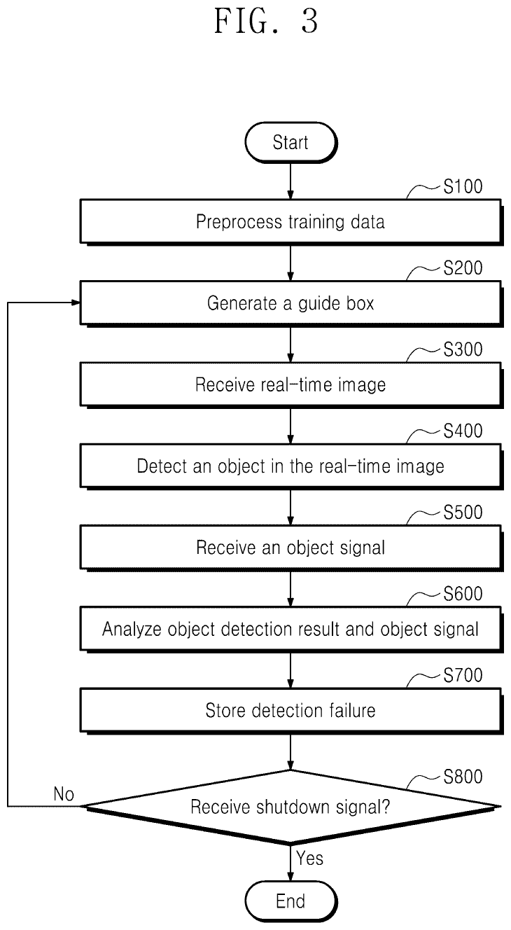

FIG. 3 is a flowchart illustrating an operation method of the detection error collection system 10 shown in FIGS. 1 and 2. The operation method of the detection error collection system 10 may include steps S100 through S700.

Referring to FIG. 3, in step S100, the data management unit 100 may preprocess the training data. In step S200, the guide generation unit 200 may generate a guide box. In step S300, the capturing unit 310 may receive a real-time image from the user. In step S400, the inference unit 400 may detect an object in the real-time image. In step S500, the operation unit 320 may receive an object signal from the user. In step S600, the analysis unit 500 may analyze the object detection result and the object signal to determine whether a detection failure has occurred. In step S700, the analysis unit 500 may store the detection failure image and associated metadata in the database 110. In step S800, the power unit 600 may receive a shutdown signal from the user.

In one embodiment, when a shutdown signal is not received by the power unit 600, the guide generation unit 200 may repeat the guide box generation. Similarly, the capturing unit 310 may continue receiving a real-time image from the user.

In one embodiment, when a shutdown signal is received by the power unit 600, the power unit 600 may cut off power to the detection error collection system 10. When the power supply to the detection error collection system 10 is cut off, the operation of the system may be terminated.

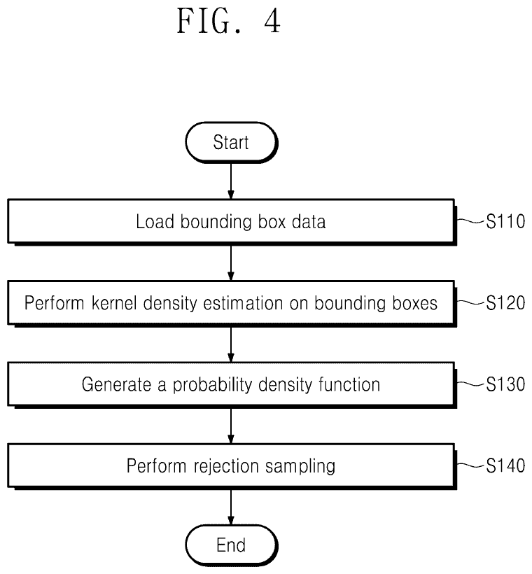

FIG. 4 is a flowchart illustrating an operation method in which the data management unit 100 performs preprocessing of training data in step S100.

Referring to FIG. 4, in step S110, the database 110 may load data related to the bounding boxes of the training data. In step S120, the preprocessing unit 120 may perform Kernel Density Estimation (KDE) on the bounding boxes. In step S130, the preprocessing unit 120 may generate a probability density function. In step S140, the preprocessing unit 120 may perform rejection sampling.

In one embodiment, the training data stored in the database 110 may include pre-existing training data, data collected by the detection error collection system 10, and large-scale public datasets. The training data may include large-scale datasets such as COCO, VOC, and CrowdHuman.

In one embodiment, the preprocessing unit 120 may perform KDE based on the location coordinates and sizes of the bounding boxes loaded from the database 110. The KDE may be determined based on equation 1, as described in conjunction with FIG. 1.

In one embodiment, the kernel function may be selected according to the distribution characteristics of the data. Kernel functions such as the Gaussian kernel, Epanechnikov kernel, Uniform kernel, Triangular kernel, Biweight (or Quartic) kernel, Triweight kernel, and Cosine kernel may be used.

In one embodiment, the preprocessing unit 120 may generate a probability density function in high-dimensional space based on the results of the KDE. For example, the preprocessing unit 120 may generate the probability density function based on equation 1. The probability density function may numerically represent the distribution characteristics of the bounding boxes. It may serve as a key criterion in processes such as sampling, anomaly detection, or statistical analysis. Since the probability density function is constructed in a non-parametric manner, it can flexibly reflect the characteristics of the data without requiring any prior assumptions about the distribution.

In one embodiment, the preprocessing unit 120 may perform rejection sampling using the generated probability density function. Through rejection sampling, the preprocessing unit 120 may conduct more frequent sampling in sparse regions.

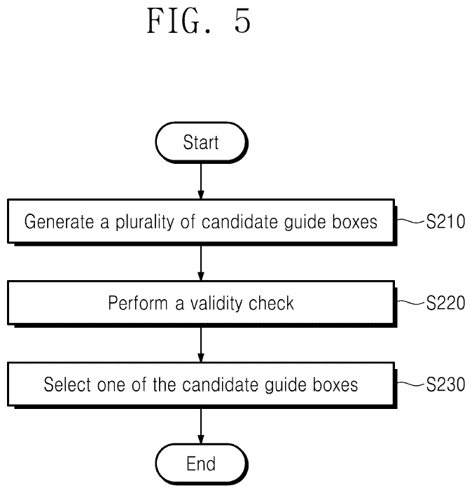

FIG. 5 is a flowchart illustrating an operation method in which the guide generation unit 200 generates a guide box in step S200.

Referring to FIG. 5, in step S210, the guide generation unit 200 may generate a plurality of candidate guide boxes. In step S220, the guide generation unit 200 may perform a validity check on the candidate guide boxes. In step S230, the guide generation unit 200 may select a final guide box.

In one embodiment, the guide generation unit 200 may generate candidate guide boxes based on sampled positions and sizes.

In one embodiment, the guide generation unit 200 may perform a validity check on the plurality of candidate guide boxes. The validity check may include determining whether a guide box extends beyond the screen boundaries, whether it overlaps with bounding boxes in the existing training data, or whether it belongs to a biased region or has a biased size.

In one embodiment, the guide generation unit 200 may display the final guide box selected through the validity check on the terminal 311 equipped with a display in the capturing unit 310.

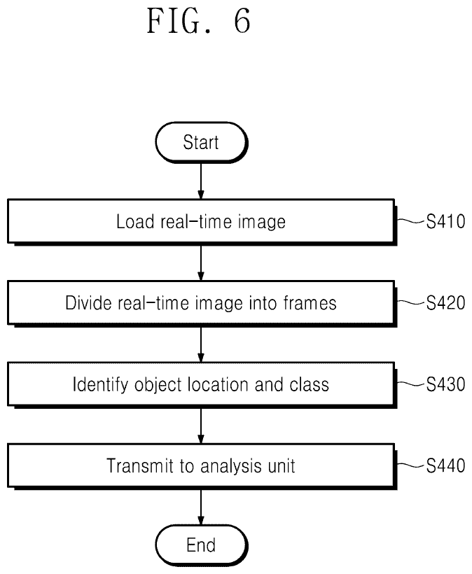

FIG. 6 is a flowchart illustrating an operation method in which the inference unit 400 detects objects in the real-time image in step S400.

Referring to FIG. 6, in step S410, the inference unit 400 may load the real-time image input by the user through the imaging unit 310. In step S420, the inference unit 400 may divide the loaded real-time image into individual frames. In step S430, the inference unit 400 may identify the location and class of object included in each frame. In step S440, the inference unit 400 may transmit the identified object location and class information to the analysis unit 500.

In one embodiment, the inference unit 400 may use a pretrained object detection model. The object detection model may include a model trained in advance using datasets collected by the detection error collection system 10 and large-scale public datasets.

In one embodiment, the inference unit 400 may use a deep learning-based object detection model. Examples of such models may include those in the YOLO (You Only Look Once) family, RetinaNet, EfficientDet, DETR (Detection Transformer), Deformable DETR, DINO, DN-DETR, and Sparse R-CNN.

In one embodiment, the inference unit 400 may identify multiple object classes including humans. The inference unit 400 may calculate a confidence score for each detected object by class, and may identify the object as a human only based on the confidence score that exceeds a predefined threshold.

In one embodiment, the inference unit 400 may transmit coordinate information regarding the position of each detected object to the analysis unit 500. The coordinate information may be expressed in the form of the top-left and bottom-right pixel coordinates of the bounding box, or in the form of center coordinates and width/height. The inference unit 400 may also transmit the class information corresponding to each object along with its confidence score to the analysis unit 500.

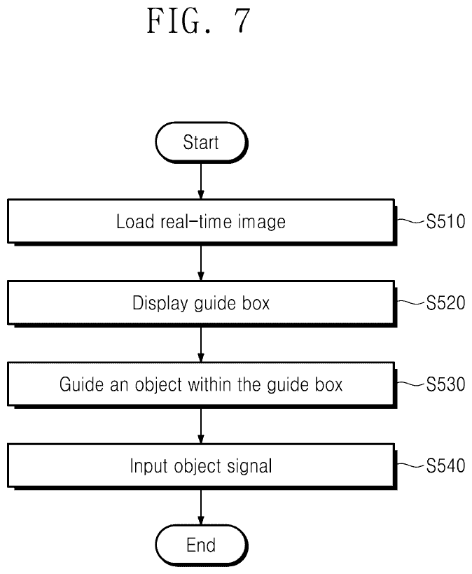

FIG. 7 is a flowchart illustrating an operation method in which the user inputs an object signal via the operation unit 320 in step S500.

Referring to FIG. 7, in step S510, the terminal 311 having a display may load a real-time image. In step S520, the terminal 311 may display a guide box on the display. In step S530, the user may guide an object into the guide box. In step S540, based on the object within the guide box, the user may input an object signal via the operation unit 320.

In one embodiment, the object signal input by the user may be used as ground truth for the inference unit 400.

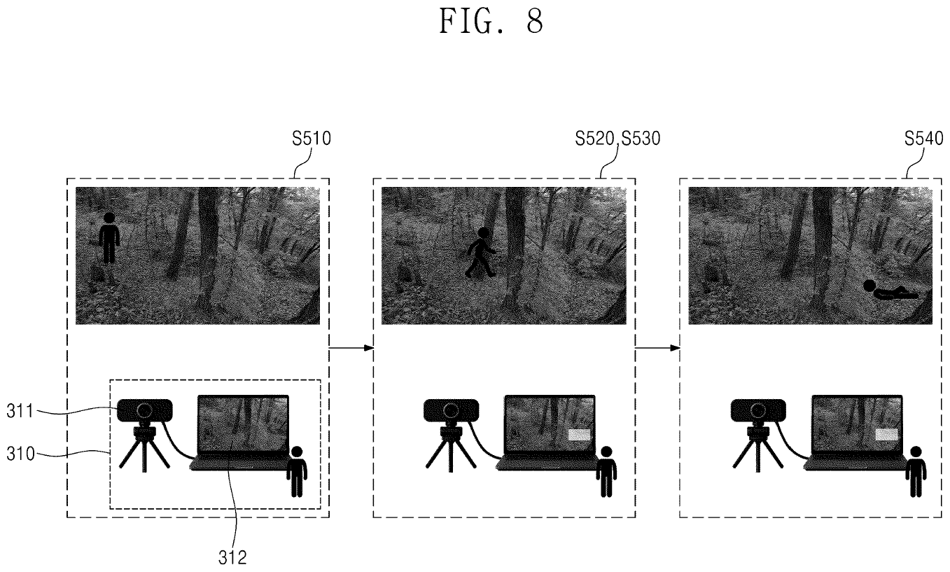

FIG. 8 is a schematic diagram illustrating an operation flow according to the embodiment of FIG. 7.

Referring to FIG. 8, in step S510, the user may set up the capturing unit 310 including the terminal 311 with a display and the camera 312 in a real environment. In steps S520 and S530, the user may guide the object present in the real environment into the guide box displayed on the display. In step S540, when the user determines that the object is positioned within the guide box, the user may input the object signal.

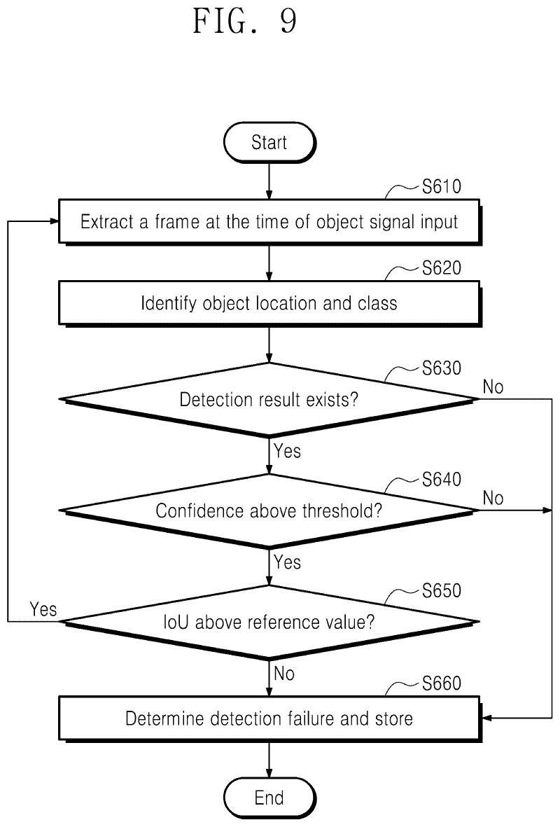

FIG. 9 is a flowchart illustrating an operation method in which the analysis unit 500 analyzes the object detection result and the object signal to determine detection failure in step S600.

Referring to FIG. 9, in step S610, the analysis unit 500 may extract the frame corresponding to the time point at which the object signal was input from the real-time image received by the capturing unit 310. In step S620, the inference unit 400 may identify the position and class of the object within the frame. In steps S630 through S650, the analysis unit 500 may determine whether detection has failed based on the existence of a bounding box, the confidence score, and the Intersection over Union (IoU) value. In step S660, based on no object detected in the frame, the analysis unit 500 may classify the frame as a detection failure and store it in the database 110.

In one embodiment, the analysis unit 500 may extract the frame at the time of object signal input, as well as the frames immediately before and after that time point.

In one embodiment, based on no predicted bounding box that exists in the frame, the analysis unit 500 may classify the frame as a detection failure. The analysis unit 500 may store metadata including the frame, frame ID, detection result, and time of user input in the database 110.

In one embodiment, even when a predicted bounding box exists in the frame, the analysis unit 500 may classify the frame as a detection failure based on the confidence score of the detection result that is below a predetermined threshold. The analysis unit 500 may store metadata including the frame, frame ID, detection result, and user input time in the database 110.

In one embodiment, the analysis unit 500 may classify the frame as a detection failure based on the Intersection over Union (IoU) between the predicted bounding box and the guide box that is less than a reference value. The reference value for classifying detection failure may be set in a range from 0 to 0.3. The analysis unit 500 may store metadata including the frame, frame ID, detection result, and user input time in the database 110.

In one embodiment, when the analysis unit 500 determines that the object detection result is not a detection failure, it may extract a frame corresponding to the new object signal input time. The analysis unit 500 may repeat the operation method of determining detection failure when the detection result is not a failure.

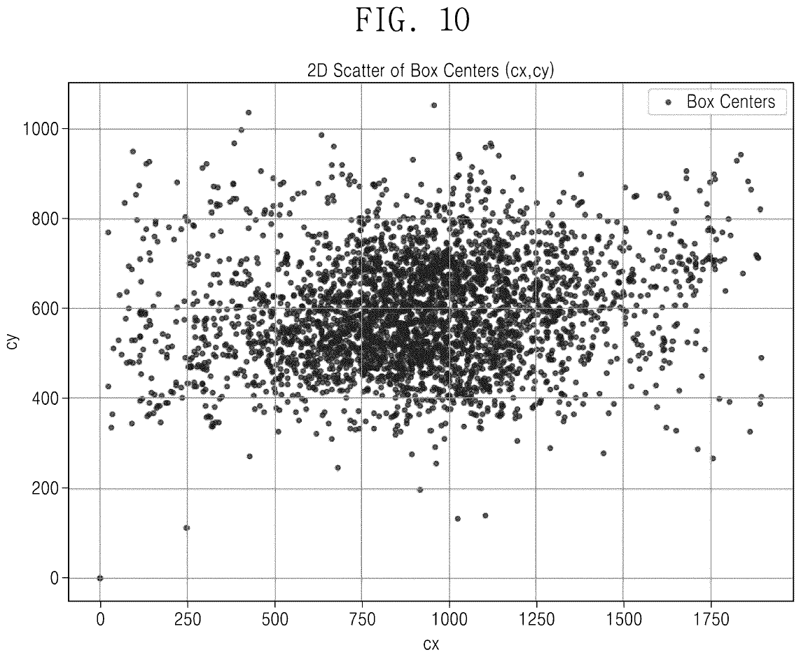

FIG. 10 is a graph illustrating the two-dimensional distribution of bounding box center coordinates collected from the training data.

Referring to FIG. 10, it can be visually confirmed that the center coordinates are biased toward a specific region.

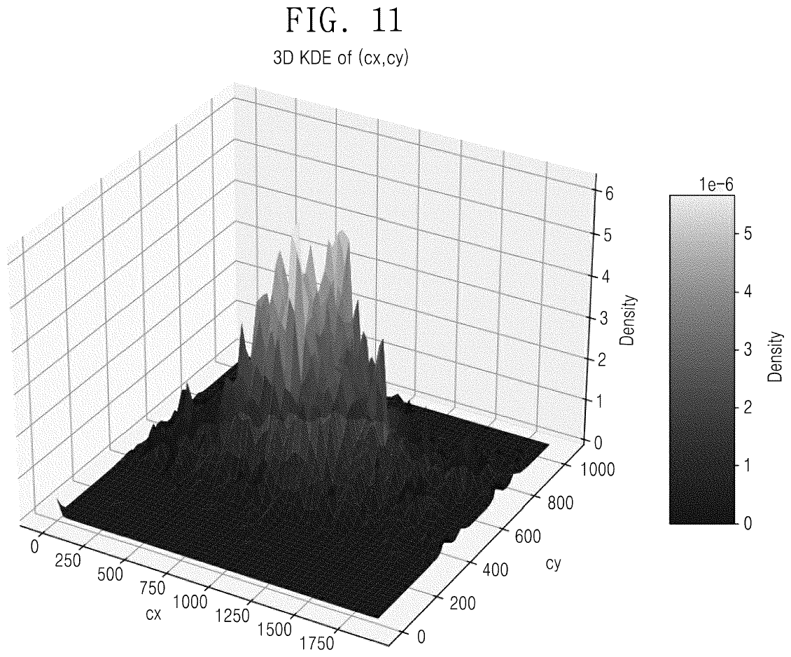

FIG. 11 is a diagram showing the results of Kernel Density Estimation (KDE) performed on the bounding box center coordinates, expressed as a heatmap.

Referring to FIG. 11, the distribution of the center coordinates is visualized as a three-dimensional density landscape, allowing the tendency of bounding boxes to concentrate in certain regions to be recognized in a more dimensional manner.

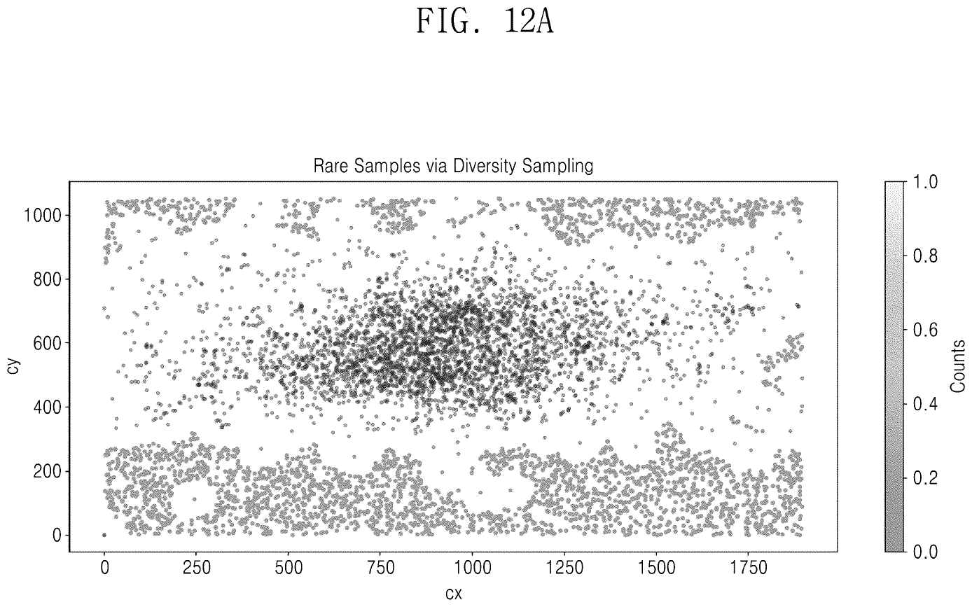

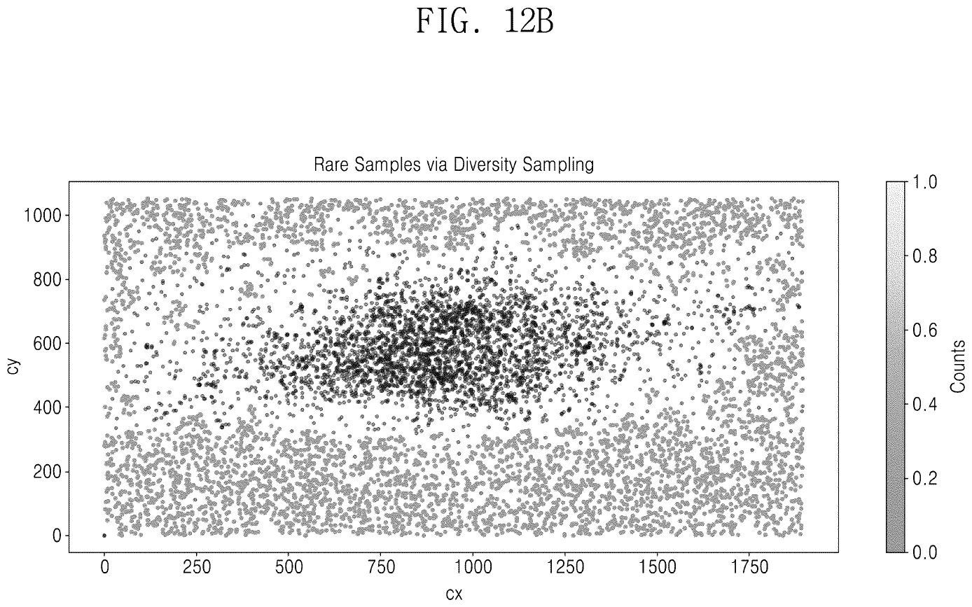

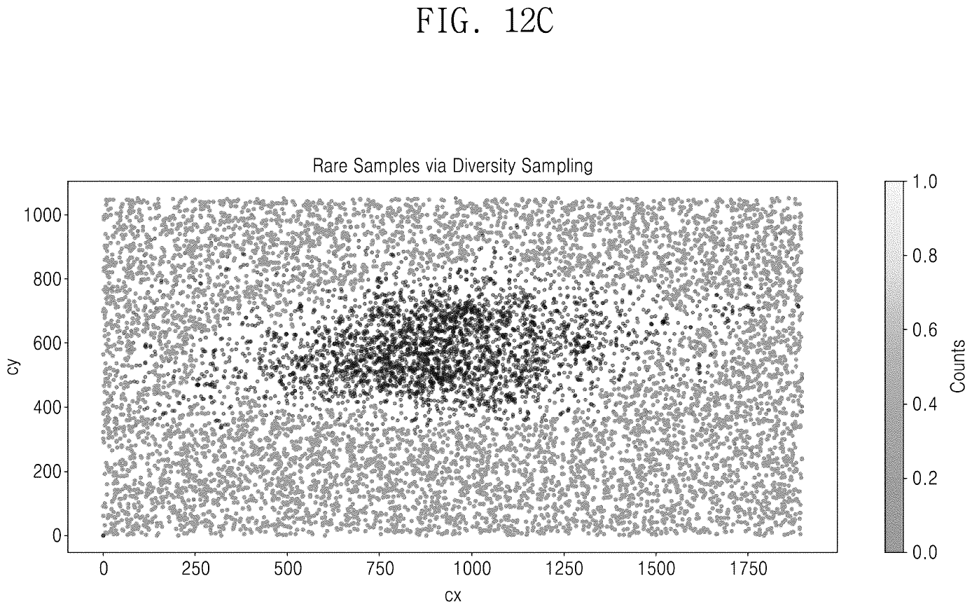

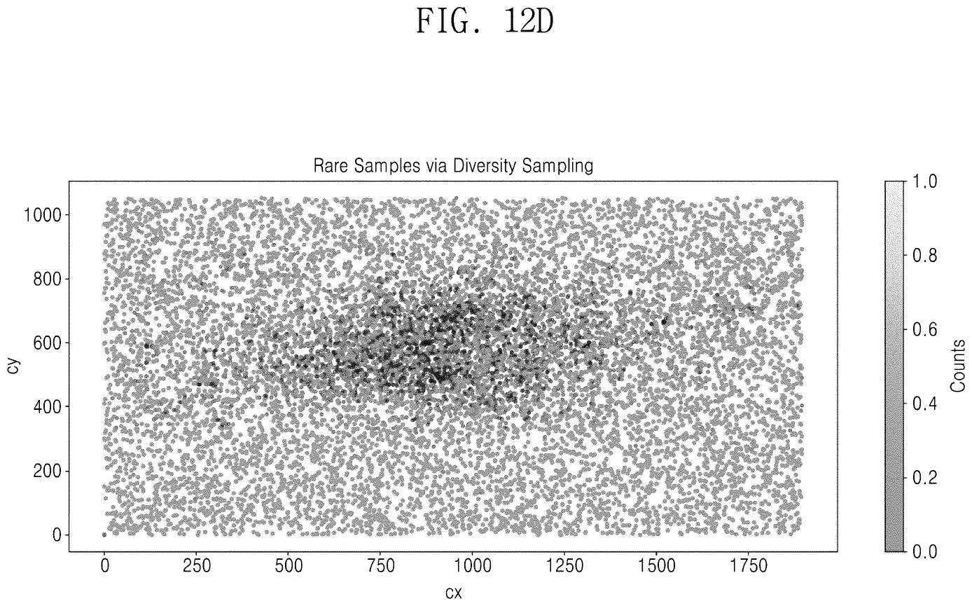

FIGS. 12A to 12D are scatter plots showing candidate guide box coordinates generated by applying rejection sampling. FIG. 12A shows the bottom 30% extracted based on the probability density values of the KDE. FIG. 12B shows the bottom 50%. FIG. 12C shows the bottom 70%. FIG. 12D shows the bottom 100%, which may be equivalent to uniform random sampling.

Referring to FIGS. 12A to 12D, it can be confirmed that, due to the influence of KDE and rejection sampling, more samples are distributed in sparse regions.

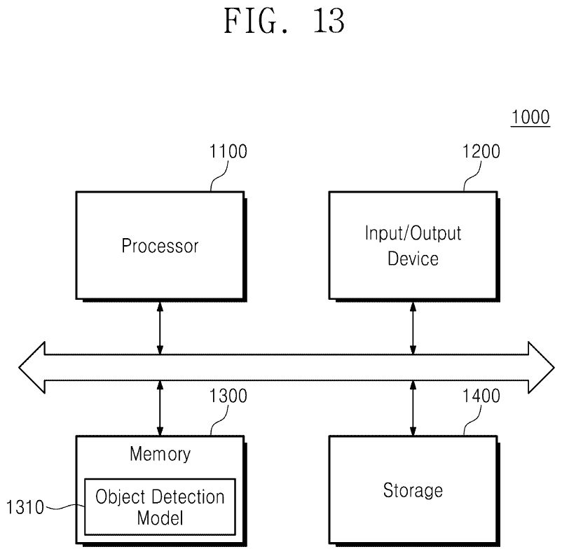

FIG. 13 illustrates a block diagram of a system according to an embodiment of the present disclosure. Referring to FIG. 13, The system 1000 may include a processor 1100, an input/output device 1200, a memory 1300, and a storage 1400. The system 1000 may represent the detection error collection system 10 described with reference to FIG. 1 and FIG. 2.

The processor 1100 may function as a central processing unit of the system 1000. The processor 1100 may perform a control operation and a computational task necessary for data management and result generation of the system 1000. For example, under the control of the processor 1100, the detection error collection system 10 may perform object detection and store and train on detection failure data. The user input unit 300 shown in FIG. 2 may be implemented as a separate hardware device that assists the processor 1100 in object detection and analysis, or performs such detection and analysis in place of the processor. The processor 1100 may operate using a computing space of the memory 1300 and may read files required to boot an operating system from the storage 1400. The processor 1100 may execute the operating system and various applications. In another example, under the control of the processor 1100, the input/output device 1200 may receive a real-time image and an object signal from the user and provide the guide box screen to the user.

The input/output device 1200 may include an interface for communication with the user of the system 1000 and a developer interface. For example, the input/output device 1200 may include at least one of various output devices such as a monitor, a printer, or a lamp. The input/output device 1200 may include at least one of various input devices such as a keyboard, a touchpad, a mouse, or a microphone.

The memory 1300 may store data and executable code to be processed or being processed by the processor 1100. For example, the memory 1300 may store the image of the training data stored in the database 110, bounding box information, information for Kernel Density Estimation (KDE) in the data management unit 100, information on the method for generating the guide in the guide generation unit 200, information for the object detection in the inference unit 400, and information for analyzing data in the analysis unit 500. The memory 1300 may serve as the main memory of the system 1000. The memory 1300 may include DRAM (Dynamic RAM), SRAM (Static RAM), PRAM (Phase-change RAM), MRAM (Magnetic RAM), FeRAM (Ferroelectric RAM), and RRAM (Resistive RAM).

An object detection model 1310 may be loaded into and executed in the memory 1300. The object detection model 1310 may implement a deep learning algorithm used in the inference unit 400 shown in FIG. 2. The object detection model 1310 may be a part of the computing space of the memory 1300. For example, firmware may be stored in the storage 1400 and may be loaded into the memory 1300 during execution. The processor 1100 may execute the firmware loaded in the memory 1300.

The storage 1400 may store data generated for long-term retention by the operating system or applications, a file required to boot the operating system, or an executable file of applications. For example, the storage 1400 may store files for executing the object detection model 1310. The storage 1400 may serve as an auxiliary memory of the system 1000. The storage 1400 may include flash memory, PRAM (Phase-change RAM), MRAM (Magnetic RAM), FeRAM (Ferroelectric RAM), and RRAM (Resistive RAM).

While the embodiments of the present disclosure have been described in detail above, the scope of the present disclosure is not limited thereto. Various modifications and improvements made by those skilled in the art based on the basic concept of the present disclosure shall also fall within the scope of the present disclosure.

The detection error collection system according to the present disclosure may clearly identify, based on user interaction, cases where an object exists in a real-world environment but the detection model fails to recognize it. Accordingly, the detection error collection system may construct an active learning dataset based on real-world environment data, and provides multiple technical effects including improved accuracy in determining detection failure, enhanced diversity and balance of training data, and maximized training efficiency of AI models in field environments.

What is claimed is:

1. A detection error collection system comprising:
a data management unit configured to store training data;
a guide generation unit configured to generate a guide box based on the training data;
a user input unit configured to receive a real-time image from a user;
an inference unit configured to detect an object included in the real-time image; and
an analysis unit configured to analyze an object detection result from the inference unit,
wherein the user input unit comprises:
a capturing unit configured to receive the real-time image based on the guide box from the user; and
an operation unit configured to receive an object signal from the user.

2. The detection error collection system of claim 1, wherein the data management unit comprises:
a database configured to store the training data and information on the training data; and
a preprocessing unit configured to perform Kernel Density Estimation (KDE) based on information on bounding boxes of the training data and to perform rejection sampling based on results of the Kernel Density Estimation.

3. The detection error collection system of claim 2,
wherein the Kernel Density Estimation (KDE) is determined based on Equation 1 below:
$$\hat{{f}_{h}} ( x ) = \frac{1}{n h} {\sum }_{i = 1}^{n} K ( \frac{x - {x}_{i}}{h} )$$
where x represents the coordinates of an existing bounding box, \hat{f}ₕ(x) denotes the estimated probability density function value, n is the number of data points, h is the bandwidth, xᵢ is the i-th observed data point, and K(⋅) is a kernel function.

4. The detection error collection system of claim 1,
wherein the guide generation unit generates a plurality of candidate guide boxes based on results provided by the data management unit,
performs a validity check on the candidate guide boxes, and selects one guide box,
wherein the validity check is performed based on whether each candidate guide box exceeds a screen boundary and whether it overlaps with bounding boxes of the training data.

5. The detection error collection system of claim 1,
wherein the capturing unit comprises a terminal having a display and a camera,
and the guide generation unit displays the guide box on the display of the terminal.

6. The detection error collection system of claim 1,
wherein the object signal is input through at least one of a shutter button click, touch input, keyboard input, and voice command.

7. The detection error collection system of claim 1,
wherein the inference unit uses a pre-trained deep learning-based object detection model,
the object detection model has been pre-trained using the training data,
and the object signal is regarded as ground truth for the object detection model.

8. The detection error collection system of claim 1,
wherein the analysis unit determines that a frame in the real-time image corresponds to a detection failure based on at least one of the following conditions:
no detection result is produced by the inference unit;
a confidence score produced by the inference unit is below a threshold; or
an Intersection over Union (IoU) between a detected bounding box and the guide box is below a reference value.

9. The detection error collection system of claim 1,
wherein the analysis unit stores a frame determined as a detection failure and associated metadata in the data management unit,
and the metadata comprises at least one of a frame ID, detection result, confidence score, and user input timestamp.

10. The detection error collection system of claim 1,
further comprising a power unit configured to control activation and termination of the detection error collection system,
wherein the power unit shuts off power supply to the detection error collection system based on a shutdown signal input by the user.

11. A method of operating a detection error collection system for collecting object detection failure data, the method comprising:
preprocessing training data by a data management unit included in the detection error collection system;
generating a guide box based on results of the preprocessing by a guide generation unit included in the detection error collection system;
receiving a real-time image from a user by a capturing unit included in the detection error collection system;
detecting an object included in the real-time image by an inference unit included in the detection error collection system;
receiving an object signal from the user by an operation unit included in the detection error collection system; and
determining a detection failure based on object detection results from the inference unit and the object signal from the operation unit by an analysis unit included in the detection error collection system.

12. The method of claim 11, wherein the preprocessing of the training data comprises:
activating the detection error collection system by a power unit;
loading bounding box data of the training data by a database;
performing Kernel Density Estimation (KDE) on coordinates and sizes of the bounding boxes by a preprocessing unit;
generating a probability density function based on result of the KDE by the preprocessing unit; and
performing rejection sampling based on the probability density function by the preprocessing unit.

13. The method of claim 12, wherein the Kernel Density Estimation (KDE) is determined based on Equation 1.

14. The method of claim 11, wherein generating the guide box comprises:
generating a plurality of candidate guide boxes based on coordinates included in the preprocessing result;
performing a validity check on the candidate guide boxes; and
selecting one of the candidate guide boxes,
wherein the validity check is performed based on whether each candidate guide box exceeds a screen boundary and whether it overlaps with bounding boxes of the training data.

15. The method of claim 11, wherein detecting the object in the real-time image comprises:
loading the real-time image by the inference unit;
dividing the real-time image into frames;
identifying an object location and a class in each frame using an object detection model; and
transmitting the object location and the class to the analysis unit.

16. The method of claim 11, wherein determining the detection failure comprises:
extracting a frame corresponding to the time of the object signal input;
applying an object detection model to the extracted frame;
determining a detection failure based on no bounding box detected;
determining a detection failure based on the confidence score below a threshold; and
determining a detection failure based on an Intersection over Union (IoU) between the predicted bounding box and the guide box below a reference value.

17. The method of claim 11, further comprising storing a frame determined as the detection failure and corresponding metadata in a database,
wherein the metadata comprises at least one of a frame ID, detection result, confidence score, and user input timestamp.

18. The method of claim 11, further comprising:
regenerating the guide box based on the preprocessing result; and
receiving a new real-time image from the user.

19. The method of claim 11, further comprising:
receiving a shutdown signal from the user by a power unit; and
shutting off power supply to the detection error collection system.
